(19) United States
(12) Patent Application Publication
(10) Pub. No.: US 2016/0341398 A1
(43) Pub. Date: Nov. 24, 2016

(54) LED LIGHTING DEVICE

(71) Applicant: KMW Inc., Hwaseong (KR)

(72) Inventors: Duk-Yong Kim, Hwaseong (KR); Byung-Ju Kang, Incheon (KR); Hyun-Ki Kim, Seoul (KR)

(21) Appl. No.: 14/715,758

(22) Filed: May 19, 2015

(51) Int. Cl. F21V 14/02; F21V 19/00; F21V 14/04; F21V 23/02; F21V 23/04; F21V 7/09; F21V 29/76

(52) U.S. Cl. CPC F21V 14/02; F21V 7/09; F21V 19/003; F21V 29/763; F21V 23/023; F21V 23/045; F21V 14/04; F21Y 2105/001

(57) ABSTRACT

Provided is an LED lighting device including: a lighting unit provided with a plurality of LEDs as a light source to generate light; a housing including an opening provided on one face, a light emitting part provided on the other face to emit light outwardly, and an inner space; a reflecting part provided on an inner face of the housing to reflect light generated from the lighting unit to the light emitting part; and a heat radiation unit provided on a rear face of the lighting unit to be exposed outwardly so as to radiate heat outwardly. The lighting unit is installed to cover the opening such that its front face is directed toward the inner space of the housing, and the light emitting part is installed to emit the light generated from the lighting unit or to emit light reflected through the reflecting part from the lighting unit.

### CROSS REFERENCE TO RELATED APPLICATIONS

This application is a continuation of International Application No. PCT/KR2014/011290 filed on Nov. 21, 2014, which claims priority to Korean Application No. 10-2013-0142968 filed on Nov. 22, 2013 and Korean Application No. 10-2014-0015569 filed on Feb. 11, 2014, which applications are incorporated herein by reference.

### TECHNICAL FIELD

The present invention relates to an LED lighting device, and more particularly, to an LED lighting device that is excellent in heat radiation characteristic and which is easy to control a light distribution.

### BACKGROUND ART

Illumination devices using existing light source means such as an incandescent lamp and a fluorescent lamp have problems of high-power consumption and a short lifespan, for example. Considering these problems, illumination devices, using an LED as a light source, have been developed, in which the LEDs consume little power and have a long lifespan. When the LED is used as a light source, the lifespan may increase remarkably compared to existing illumination devices. As a result, the quantity of waste can also be greatly reduced to prevent environmental pollution. In addition, since the power consumption is reduced, it is expected that the LED illumination devices may contribute to energy saving.

However, despite the advantages described above, the LED has a problem in that it generates a large quantity of heat. When the heat generated from the LED is not radiated to the outside, the life span of the LED illumination devices will be reduced and thus, the long lifespan effect according to the use of the LED as a light source cannot be achieved as expected.

In addition, the LED illumination devices require a Switching Mode Power Supply (SMPS) which converts an external Alternating Current (AC) power into a direct current (DC) power to be supplied to the LED. For example, Korean Registered Utility Model No. 20-0451090 discloses an LED landscape illumination lamp equipped with an SMPS, in which a substrate, on which an LED is mounted, and the SMPS are positioned to be opposite to each other with a support face being interposed therebetween. However, the SMPS itself generates heat. Accordingly, the LED landscape lamp has a problem in that the heat generated from the SMPS and the heat generated from the LED interact with each other so that the lifespans of both the SMPS and the LED are shortened.

Meanwhile, among LED illumination devices, in high-output LED lighting devices (typically outputting 100 watt or more), high-power LED chips (e.g., 1 watt LED chips) have been used as light sources. This is because the number of LED chips required when low-power LED chips (FIG. 1) are used should be relatively larger than the number of LED chips required when high-power LED chips (FIG. 2) are used (see FIG. 1), and as a result, light distribution becomes difficult to control. For example, when 1 watt high-power LED chips are used, one hundred LED chips are required in order to provide a high output of 100 watt. However, when 0.2 watt low-power LED chips are used, five hundred LED chips are required and due to the increase of the number of light sources, the light distribution becomes difficult to control. In particular, in a case where high-output lighting is provided within a predetermined area in order to replace existing lighting, the light distribution becomes more difficult to control as the number of LED chips increases. Thus, high-power LED chips are used.

However, since the high-power LED chips generate a lot of heat compared to the low-power LED chips, it is necessary to put more effort in heat radiation. Despite the degradation of the heat radiation characteristic, there has been no choice but to use the high-power LED chips in order to control the light distribution more easily. When a high-output lighting device is implemented using high-power LED chips as described above, a large heat radiation means is required, and as a result, problems occurs in that the volume and weight of the device increase and the manufacturing costs also greatly increase. Especially, in a case of transparent lighting, due to a fact that a lighting device has a large size and consumes a lot of power, what is requested is a lighting device that is compact and consumes little power.

### SUMMARY

In order to solve the problems as described above, one embodiment of the present invention is intended to provide an LED lighting device which is capable of easily radiate heat generated from LEDs, preventing the heat generated from the LEDs from being transferred to the surroundings, and controlling a light distribution in a desired form.

In addition, one embodiment of the present invention is intended to provide an LED lighting device that is capable of blocking heat conduction between a power supply and a lighting unit.

An LED lighting device according to one embodiment of the present invention includes: a lighting unit provided with a plurality of LEDs as a light source to generate light; a housing including an opening provided on one face, a light emitting part provided on the other face to emit light outwardly, and an inner space; a reflecting part provided on an inner face of the housing to reflect light generated from the lighting unit to the light emitting part; and a heat radiation unit provided on a rear face of the lighting unit to be exposed outwardly so as to radiate heat outwardly. The lighting unit is installed to cover the opening such that its front face is directed toward the inner space of the housing, and the light emitting part is installed to emit the light generated from the lighting unit or to emit light reflected through the reflecting part from the lighting unit.

An LED lighting device according to another embodiment of the present invention includes: a lighting unit including a substrate, on which a plurality of low-power LED chips are mounted; a housing including a bottom face, a first inclined face formed an acute angle with the bottom face, and a second inclined face connected with the first inclined face, in which opposite ends of the bottom face, the first inclined face, and the second inclined face are connected with each other to form an inner space defined by the bottom face, the first inclined face, and the second face as boundaries; and a reflecting part on an inner face of the housing to reflect light generated from the lighting unit. At least a part of the lighting unit is inserted through a part of the first inclined face such that the low-power LED chips are directed to the inner space of the housing.

### BRIEF DESCRIPTION OF THE DRAWINGS

FIG. 1 illustrates an arrangement of LED chips of an LED lighting device according to one embodiment of the present invention;

FIG. 2 illustrates an arrangement of LED chips of an LED lighting device according to another embodiment of the present invention;

FIG. 3 is a perspective view illustrating an LED lighting device according to one embodiment of the present invention in a disassembled state;

FIG. 4 is a cross-sectional view illustrating the LED lighting device of FIG. 3 in the assembled state;

FIG. 5 is a cross-sectional view illustrating an inclined angle of a reflecting face of the LED lighting device of FIG. 3.

FIG. 6 is a plan view illustrating an LED lighting device according to one embodiment of the present invention, in which reflecting parts are provided on side faces;

FIG. 7 is a perspective view illustrating a fixing frame applied to an LED lighting device according to one embodiment of the present invention in a disassembled state;

FIG. 8 is a perspective view of an LED lighting device according to another embodiment of the present invention;

FIG. 9 is a side view of the LED lighting device of FIG. 8; FIG. 10 is a view illustrating a part of the LED lighting device of FIG. 9 in an enlarged scale;

FIG. 11 is a cross-sectional view of an LED lighting device according to one embodiment of the present invention;

FIG. 12 is a view illustrating light emission of an LED lighting device in a case where an inclined angle “a” is 0 degrees;

FIG. 13 is a view illustrating light emission of the LED lighting device when the inclined angle “a” is 45 degrees; and

FIG. 14 illustrates a light distribution diagram and a direct downward illuminance diagram of an LED lighting device according to one embodiment of the present invention.

### DETAILED DESCRIPTION

Hereinafter, LED lighting devices of the embodiments of the present invention will be described in detail with reference to the accompanying drawings.

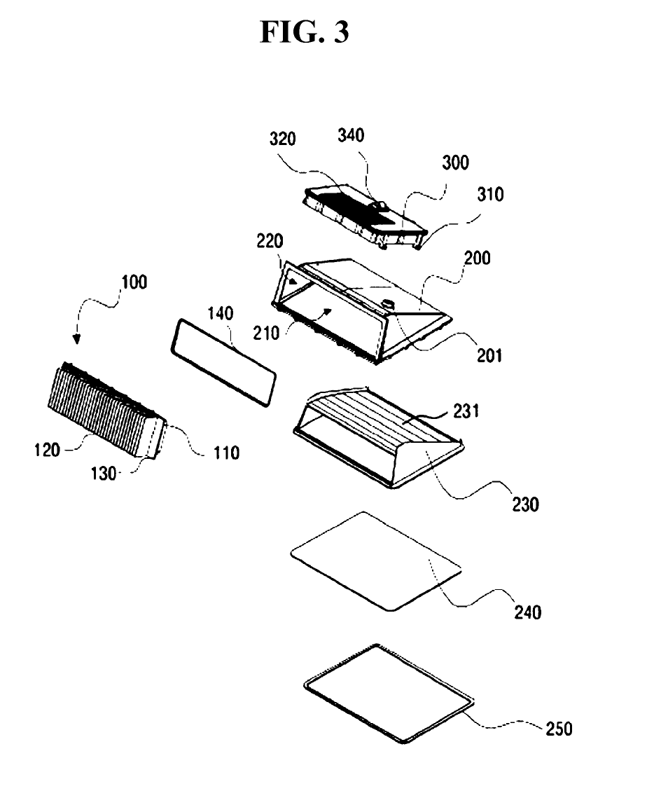

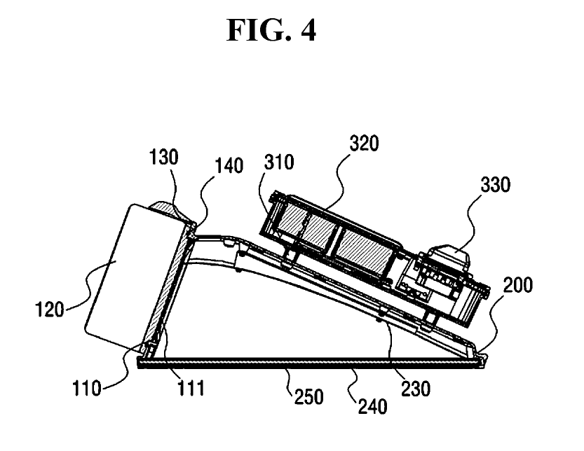

FIG. 3 is a perspective view illustrating an LED lighting device according to one embodiment of the present invention in a disassembled state, and FIG. 4 is a cross-sectional view illustrating the LED lighting device of FIG. 3 in the assembled state.

The LED lighting device according to one embodiment of the present invention includes: a lighting unit 100 provided with a plurality of LEDs as light sources to generate light; (a housing 200 including an opening 220 provided on one face, a light emitting part 210 provided on the other face to emits light outwardly, and an inner space; a reflecting part 230 provided on an inner face of the housing 200 to reflect the light generated from the lighting unit 100 to the light emitting part 210; and a heat radiation unit 120 provided on a rear face of the lighting unit 100 to be exposed outwardly so as to radiate the heat outwardly. In the LED lighting device, the lighting unit 100 is installed to cover the opening 220 such that its front face is directed toward the inner space of the housing 200, and the light emitting part 210 is installed to emit the light generated from the lighting unit 100 or to emit the light reflected through the reflecting part 230 from the lighting unit 100.

1. Lighting Unit

As illustrated in FIG. 3, according to one embodiment of the present invention, the lighting unit 100 includes a substrate 110, a plurality of LEDs 111 placed on the substrate 110, and a metal plate 130 that supports the substrate 110. As for the LED light sources, LED chips are preferably used. COB (chip on board) type LED chips may also be used.

The LED chips are preferably low-power LED chips. As for the low-power LED chips, chips of 0.1 watts to 0.6 watts, preferably 0.2 watts to 0.5 watts may be used. Since the number of chips when low-power LED chips are used is larger than the number of chips when high-power LED chips having a higher power are used to provide the same output on the same area, the low-power LED chips are distributed such that the intervals between neighboring chips are narrower.

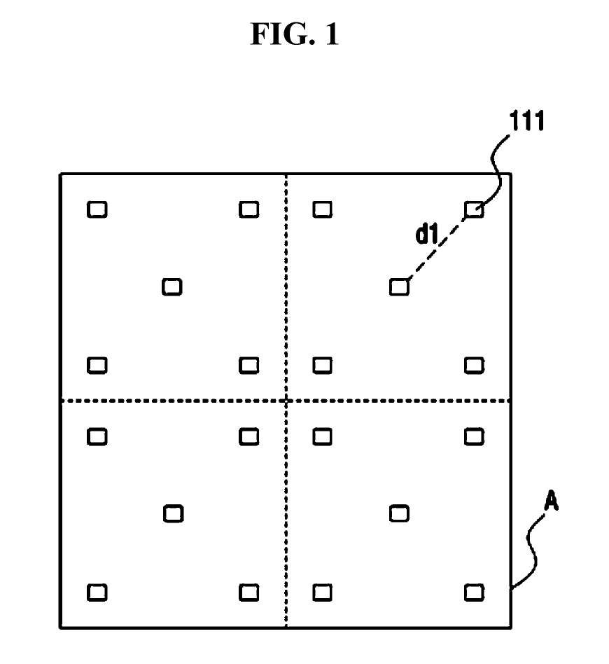

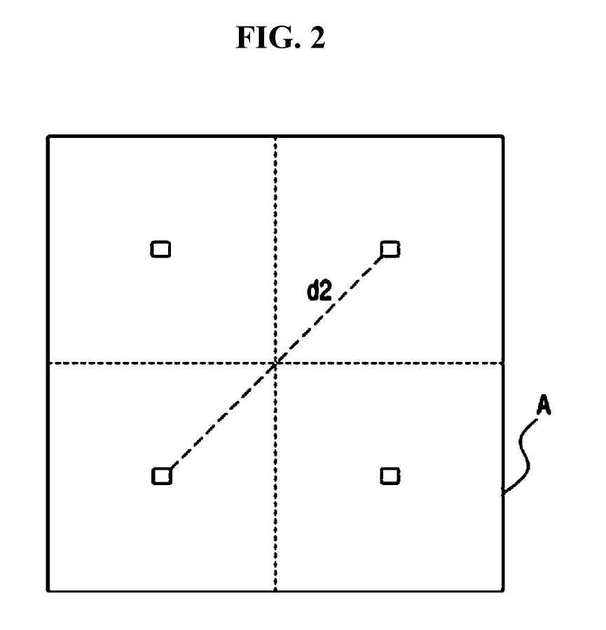

FIGS. 1 and 2 illustrate lighting units of LED lighting devices according to embodiments of the present invention, more specifically an arrangement of low-power LED chips 111 and an arrangement of high-power LED chips 111 on the substrate, respectively. As illustrated in FIGS. 1 and 2, in the LED lighting device using the low-power LED chips, five 0.2 watt LED chips may be arranged in a unit area (the parts indicated by “A” in the drawings) (FIG. 1) while in the LED lighting device using the high-power LED chips, one 1 watt LED chip may be arranged in the unit area (FIG. 2). Thus, the interval between each two adjacent low-power chips, which is indicated by “d1” in FIG. 1, is narrower than the interval between each two adjacent high-power chips which is indicated by “d2” in FIG. 2. Although not illustrated, an LED lighting device, according to a modified embodiment of the present invention, may include ten 0.1 watt LED chips, four 0.25 watt LED chips, or two 0.5 watt LED chips arranged within the unit area according to desired design specifications and/or customers' requests.

Since each of the LED chips 111 serves as a heat transfer point that transfers heat and a heat source, LED lighting devices using the low-power LED chips according to one embodiment of the present invention may transfer or radiate heat generated from the used LED chips to the substrate more uniformly (evenly). The low-power LED chips are more inexpensive, consume less power, and generate a smaller amount of heat than the high-power LED chips. In addition, the low-power LED chips have a higher brightness efficiency than the high-power LED chips. For example, theoretically, there is a lumen difference per watt between the light beam of each of five 0.2 watt LED chips and the light beam of the one 1.0 watt LED chip. That is, the 0.2 watt LED chip has about 160 lm/w while the 1.0 watt LED chip has about 140 lm/w, which means that the optical efficiency of the low-power LED chips is higher than that of the high-power LED chips.

According to one embodiment of the present invention, the high-power LED chips (e.g., LED chips, of which the power consumption is about 1 watt) may also be used. When the high-power LED chips are used, the heat generated from the chips has a relatively high temperature as compared that generated from the low-power chips, which may generate a heat island phenomenon. In addition, since the interval between each two neighboring chips is longer than that in the low-power LED chips in the same area, heat conduction may become difficult. Due to this, the lifespan of the high-power LED chips may be shortened. Accordingly, heat radiation design is far more important in the high-power LED chips. Accordingly, when the high-power LED chips are used, all the heat radiation design factors to be described below are preferably provided if possible. Since an amount of generated heat and a light distribution characteristic of the chips should be varied depending on the types of chips, the design and structure of a lighting device should be adjusted accordingly.

In one embodiment of the present invention, the lighting unit 100 is detachable from/attachable to the housing 200 so that the lighting unit 100 can be easily replaced and repaired. The lighting unit 100 is installed to close an opening 220 of the housing 200 in a state where the front face, on which the LEDs are installed, is directed toward the inner space of the housing 200. For example, the lighting unit 100 may be installed by being inserted into and coupled to the opening 220 of the housing 200.

In one embodiment of the present invention, the metal plate 130, to which the substrate 110 is attached, has an inclined angle of an acute angle with respect to the ground. As a result, the LEDs 111 mounted on the substrate 110 are arranged to be inclined with respect to the ground. It may be understood that this is to increase the illuminance in a directly downward direction of the LED lighting device according to one embodiment of the present invention.

In addition, in one embodiment of the present invention, the metal plate 130 may be manufactured by various methods. The metal plate 130 may be an extrusion-molded product, which is manufactured through extrusion molding. In the case where the metal plate 130 is an extrusion-molded product and the housing 200 is an injection-molded product, the thermal conductivity of the metal plate 130 is higher than that of the housing 200, and thus, the heat generated from the LED chips can be rapidly conducted through the metal plate 130 rather than through the housing 200.

2. Heat Radiation Unit

Referring to FIG. 3, a heat radiation unit 120 is provided on the rear face of the lighting unit 100 to be exposed outwardly, thereby radiating the heat outwardly. Heat radiation fins may be preferably used for the heat radiation unit 120. In this case, a plurality of heat radiation fins 120 protrudes on the rear face 130 of the metal plate 130, and the substrate 110 may be fixedly installed on the front face of the metal plate 130, as illustrated in FIG. 4. The LED chips 111 are mounted on the substrate 110 as light sources. When heat generated from the LED chips 111, the heat may be rapidly transferred to the heat radiation fins 120 through the metal plate 130. When the thermal conductivity of the metal plate 130 is higher than that of the housing 200 as described above, the heat transfer to the heat radiation fins 120 may be executed more rapidly. The heat transferred to the heat radiation fins 120 can be easily radiated through heat exchange with the external air from the heat radiation fins 120. The number, shapes, and positions of the heat radiation fins 120 may be properly selected according to design specifications and/or a customers' request. For example, the heat radiation fins 120 may be formed horizontally. In addition, as illustrated in FIG. 3, the heat radiation fins 120 may be formed in the vertical direction or in an inclined direction. When the heat radiation fins 120 are formed in the vertical direction or in an inclined direction with respect to the ground, foreign matter such as dusts may fall down by gravity so that degradation of a heat radiation characteristic caused by deposition of foreign matter can be prevented. In particular, when the heat radiation fins 120 are formed in the vertical direction, convection of air can be facilitated. That is, when heat radiation fins 120 are formed in the vertical direction, the air heat-exchanged in the space formed between the heat radiation fins 120 may smoothly ascend without resistance to form a convection flow. Thus, the heat radiation fins 120 are formed preferably in an inclined direction with respect to the ground, more preferably in the vertical direction. At least one of the heat radiation fins 120 may be formed in the horizontal direction and/or at least one of the heat radiation fins 120 may be formed in the inclined direction or vertical direction.

In some embodiments, the heat radiation fins 120 and the metal plate 130 may be separately formed and interconnected with each other through a proper method. In other embodiments, the heat radiation fins 120 and the metal plate 130 may be integrally formed through a process such as extrusion molding or injection molding. Typically, even with the same material, an extrusion-molded product has a thermal conductivity higher than that of an injection-molded product. Thus, the heat radiation fins 120 and the metal plate 130 are formed preferably integrally, more preferably, through extrusion molding. In this case, the heat radiation effect is high due to the high thermal conductivity. In addition, the metal plate 130 and the heat radiation fins 120 are made of, preferably a material having a thermal conductivity higher than that of the housing 200.

3. Housing

According to one embodiment of the present invention, the housing 200 includes a bottom face, a first included face forming an acute angle with the bottom face, and a second inclined face forming an acute angle with the bottom face and connected with the first inclined face. In the housing 200, the ends of the bottom face, the first inclined face, and the second inclined face are connected with each other to form an internal space defined by the bottom face, the first inclined face, and the second inclined face as boundaries. The opening 220 is provided through the first inclined face of the housing 200 and the light emitting part 210 is provided on the bottom face. The angle formed by the bottom face and the first inclined face, the angle formed by the first inclined face and the second inclined face, and the angle formed by the second inclined face and the bottom face are set to satisfy desired design specifications and/or a customers' request.

In some embodiments of the present invention, the housing 200 may be formed through a process such as extrusion molding or injection molding. Preferably, the housing 200 is formed through the injection molding in its entirety. This is because the housing 200 as an injection-molded product has a relatively low thermal conductivity so that heat conduction of the heat generated from the LEDs 111 to a power supply 300 or conversely, conduction of the heat generated from the power supply 300 to the LEDs 111 may be reduced.

In another embodiment of the present invention, a material have a relatively low thermal conductivity compared to the metal plate 130 and the heat radiation fins 120 is preferably used for the housing 200. This is because heat conduction between the lighting unit 100 and the power supply 300 through the housing 200 can be further reduced. In order to enable molding without using an insert in an injection mold, the first inclined face provided with the opening 220 is formed to be inclined with respect to the ground.

According to one embodiment of the present invention, in the lighting unit 100, in particular between the metal plate 130, on which the LED chips are mounted, and the housing 200, a heat insulation sealing unit 140 is disposed. The heat insulation sealing unit 140 is formed of, preferably, a material having a low thermal conductivity. The heat insulation sealing unit 140 prevents infiltration of water into the inside of the housing 200 and at the same time, blocks the conduction of the heat generated from the LEDs 111 to the housing 200. In addition, the heat insulation sealing unit 140 blocks the conduction of the heat generated from the power supply 300 to the lighting unit 100.

4. Reflecting Part

According to one embodiment of the present invention, a reflecting part 230 may be installed on an inner face of the housing 200 to reflect the light generated from the lighting unit 100 to the light emitting part (see FIG. 3).

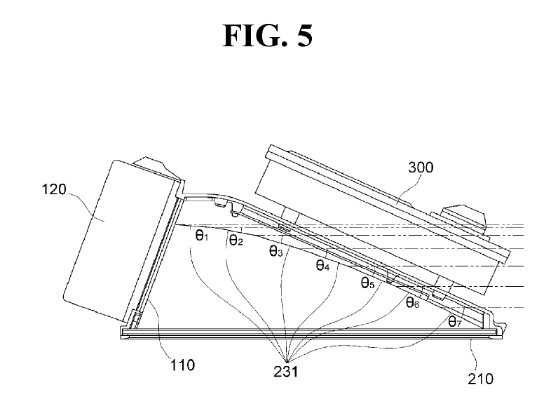

As illustrated in FIG. 5, the reflecting part 230 may be formed of a plurality of reflecting faces 231, in which the respective reflecting faces 231 have different inclined angles 01, 02, 03, . . . , different curvatures, different areas, or at least two of these features so as to implement a pre-set light distribution characteristic when light is emitted through the light emitting part 210. By using the reflecting part 230 having the plurality of reflecting faces 231 with different inclined angles, the light distribution may be efficiently controlled. In particular, even in a case where low-power LED chips are used as light sources, i.e., in a case where the number of chips increases further so that the light distribution is difficult to control, a desired light distribution can be easily obtained. In order to implement the pre-set light distribution characteristic as described above, the number of the low-power LED chips 111 and the interval between each two neighboring chips can be adjusted. Furthermore, the structure and shape of the reflecting part 230 can be preferably designed. For example, the LED chips may be mounted on the lighting unit 100 so that at least a part of light generated from the LED chips 111 can reach the reflecting part 230. According to one embodiment of the present invention, as illustrated in FIG. 5, the reflecting faces may be designed such that a reflecting face nearer to the lighting unit 100 has a narrower area and a reflecting face farther away from the lighting unit has a wider area.

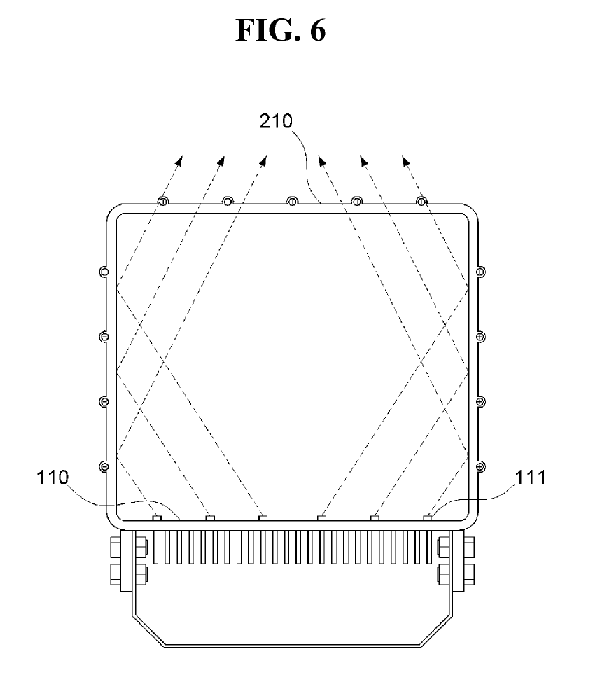

As illustrated in FIG. 5, the reflecting part 230 may be formed on the ceiling within the housing 200, on the opposite side faces of the housing 200, or on the ceiling and the opposite side faces of the housing 200. FIG. 6 is a plan view of a lighting device according to one embodiment of the present invention. As illustrated, the light generated from the LED chips 111 on the substrate 110 are reflected laterally and then emitted outwardly through the light emitting part 210.

In addition, since the reflecting part 230 is provided to be attachable to/detachable from the housing 200, replacement and repair are easy to perform and further, the light distribution characteristic can be freely adjusted.

Various materials, such as aluminum, may be used for the reflecting part 230. In addition, various coating methods may be used for forming the reflecting part 230.

For example, a method of depositing silver (Ag) on a Poly Carbonate (PC) to be coated or laminated may be used.

5. Light Emitting Part

According to one embodiment of the present invention, a cover 240 is installed on the light emitting part 210 to cover the light emitting part 240. The cover 240 prevents foreign matter such as dusts from infiltrating into the housing 200. The cover 240 may be fixed to the housing 200 through a method known in the corresponding technical field. An LED lighting device according to one embodiment of the present invention includes a fixing frame 250 that fixes the cover 240. The configuration and actions of the fixing frame 250 will be described in more detail below.

6. Power Supply

According to one embodiment of the present invention, the power supply 300 that supplies power to the lighting unit 100 is mounted on an outer face of the housing 200. At least one power supply port 201 is provided on the outer face of the power supply 300 so as to supply power to the substrate 110. The power supply 300 may be detachably or non-detachably mounted. In view of replacement or repair, the detachable type is more preferable. As illustrated in FIG. 4, since the power supply 300 is installed on the upper portion of the housing 200 so that the entire outer face of the power supply 300 is exposed to the atmosphere, the LED lighting device according to one embodiment of the present invention may have an excellent heat radiation characteristic. In particular, the power supply 300 may be installed to be inclined with respect to the ground as illustrated in FIG. 4 and as a result, deposition of foreign matter, such as dusts, and resistance by wind may be reduced.

According to one embodiment of the present invention, the power supply 300 is provided with fastening lugs 310 protruding downwardly (FIG. 4). The fastening lug 310 may be mounted on the outer face of the housing 200 to be in contact with the top face of the housing 200 with a gap being interposed between the power supply 300 and the outer top surface of the housing 200. Since the power supply 300 and the housing 200 are in contact with each other only through the fastening lugs, heat conduction between the power supply 300 and the housing 200 may be reduced. In addition, a space exists between the power supply 300 and the housing 200 except for the portion connected through the fastening lugs, the heat radiation effect can be enhanced. In another modified embodiment, as illustrated in FIG. 4, a heat radiation part 320 is also provided on the outer face of the power supply 300 so that heat radiation from the power supply 300 itself to the outside may be performed. As for the heat radiation part 320, heat radiation fins may be preferably used. The heat radiation fins are formed preferably to be inclined with respect to the ground, more preferably, in the vertical direction.

In another modified embodiment, the power supply 300 may be provided with an antenna 340 that receives a wireless signal so that the power supplied to the substrate 110 can be adjusted wirelessly from the outside (FIG. 3), and may include a controller that controls supply of the power according to the wireless signal received through the antenna 340.

The positions of the light emitting part 210, the opening 220, and the power supply 300 mounted on the outer face of the housing 200 may be determined depending on design specifications and/or customers' requests. For example, in some embodiments, as illustrated in FIGS. 3 and 4, the light emitting part 210 may be provided on the bottom face of the housing 200, and the opening 220 may be formed to be inclined from one end of the bottom face toward the top side, and the outer face, on which the power supply 300 is mounted, may be formed to be inclined from the other end of the bottom face toward the top side.

7. Fixing Frame

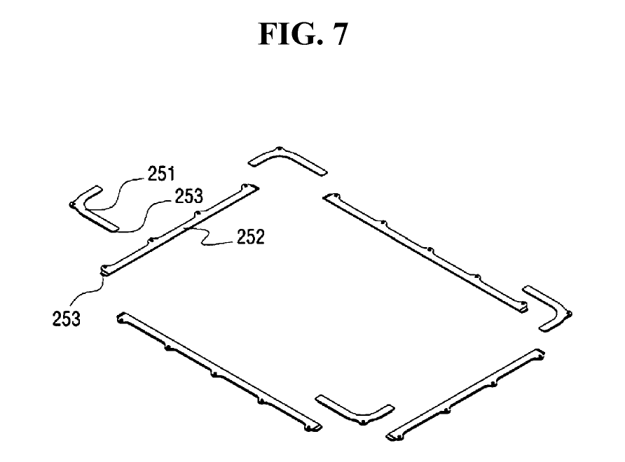

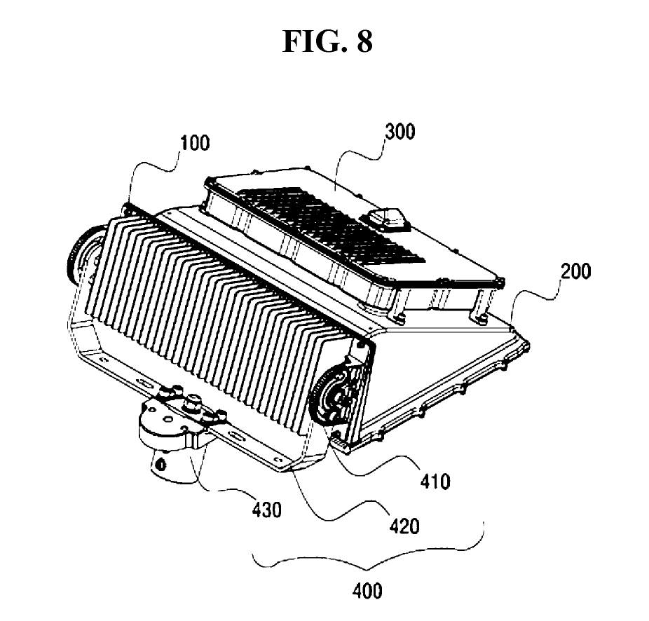

FIG. 3 illustrates a fixing frame 250 applied to an LED lighting device according to one embodiment of the present invention, and FIG. 7 illustrates the fixing frame 250 in a disassembled state.

As illustrated in FIG. 7, according to one embodiment of the present invention, the fixing frame 250 has a configuration that is divided into a plurality of frames. That is, the fixing frame 250 is formed generally in a window frame shape by assembling a plurality of bent frames 251 and linear frames 252 with each other.

The bent frames 251 come in contact with apexes of the cover 240 and edges around the apexes, respectively, and the linear frames 252 come in contact with the edges of the cover 240 between the bent frames 251, respectively (see FIGS. 3 and 7). In addition, each of the bent frames 251 and the linear frames 252 is coupled around the bottom light emitting part 210 of the housing 200 through coupling mechanisms, such as bolts. In particular, the bent frames 251 and the linear frames 252 may be coupled to be partly overlapped, and the overlapped parts may be provided with stepped portions 253 having complementary shapes to be engaged with each other.

In this structure, the bent frames 251 may be assembled to the housing 200 with the cover 240 being interposed therebetween, and the linear frames 252 may be assembled to the housing 200. At this time, the stepped portion 253 formed in each end portion of a linear frame 252 may be in contact with the corresponding stepped portion 253 of a bent frame 251 to be engaged with the stepped portion 253, and the edge of the linear frame 252 may be substantially in close contact with the bent frame 251 to be fixed.

Since the bent frames 251 and the linear frames 252 are fixed to each other through the close contact and fixation between the stepped portions 253, the use of bolts for fixing opposite end portions of the bent frames 251 and the opposite end portions of the linear frames 252 may be omitted. Thus, the time required for an assembling process can be shortened and the manufacturing costs can be reduced.

In the case of the divided fixing frame 250 as described above, even if a lighting device with a different size is changed, the fixing frame 250 can be used merely by changing the lengths of the linear frames 252 to be suitable for the size. Thus, with the divided fixing frame 250, it is not necessary to produce various frames by models so that the production costs can be reduced. In addition, although a fixing frame produced in an integral form may be deformed during storage, the divided fixing frame 250 according to one embodiment of the present invention does not tend to be deformed since it is divided. In addition, the divided fixing frame 250 may be easily stored by reducing the volume thereof.

8. Miscellaneous

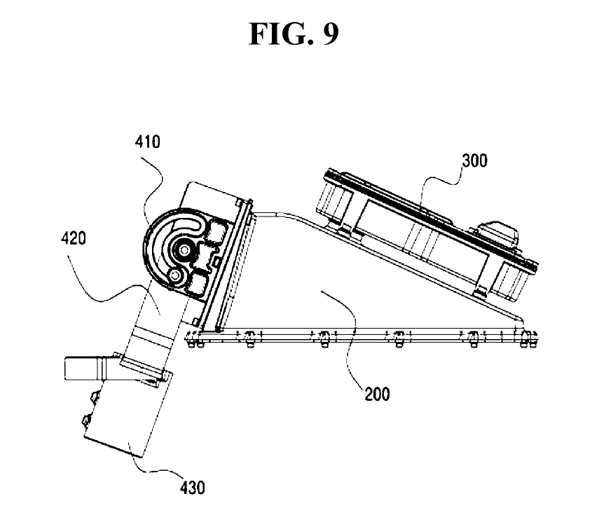

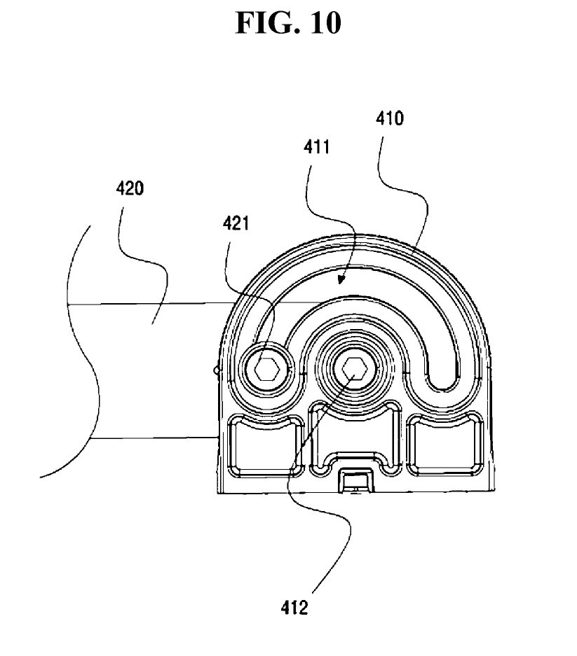

FIG. 8 is a perspective view of an LED lighting device according to another embodiment of the present invention, FIG. 9 is a side view of the LED lighting device of

FIG. 8, FIG. 10 is a view illustrating a part of the LED lighting device of FIG. 9 in an enlarged scale.

Referring to FIGS. 8 to 10, an LED lighting device according to another embodiment of the present invention further includes an angle adjusting unit 400 coupled to the lighting unit 100 so as to tilt and pivot the LED lighting device according to the above-mentioned embodiments.

According to one embodiment of the present invention, the angle adjusting unit 400 includes a first pivot bracket 410 fixed to one side end of the rear face of the lighting unit 100, a second pivot bracket 410 fixed to the other side end of the rear face of the lighting unit 100, a pivot fame 420 pivotally connected with the first pivot bracket 410 at one end and pivotally connected with the second pivot bracket at the other end, and an arm socket 430 coupled to a part of the pivot frame 420 to be attachable/detachable, and joined with a light stem (see FIGS. 8 and 9). The arm socket 430 allows an assembled structure of the lighting unit 100, the housing 200, and the power supply 300 to be pivoted according to the joined angle.

By pivoting the pivot frame 420, a reflection angle of the light emitted from the LEDs 111 through the reflecting part 230, and an emission angle of the light through the light emitting part 210 may be adjusted (see FIG. 9). As illustrated in FIG. 10, the pivot brackets 410 include a rotation shaft 412 at the centers thereof, in which the rotation shaft penetrates a part of the pivot frame 420 to be fixed to a side face of the lighting unit 100. Each of the pivot brackets 410 is provided with a circular arc-shaped penetration part 411 with the rotation shaft 412 as the center. Thus, the pivot frame 420 may be fixed not to be pivoted by tightening an anchoring bolt 421 coupled to one or each of the pivot brackets 410 through the penetration part 411 in a state where the pivot angle of the pivot frame 420 is properly adjusted.

The pivot frame 420 has a “U” shape in a plan view, and the arm socket 430 may be coupled to the face of the pivot frame 420, which is parallel with the lighting unit 100. The arm socket 430 may be substituted by sockets or fastening members having various shapes or profiles as needed.

When the angle adjusting unit 400 configured as described above is used with the lighting device according to one embodiment of the present invention, the light emission direction may be adjusted regardless of an installation position (FIG. 8). As a result, the LED lighting devices according to the embodiments of the present invention are applicable to various fields including a street lamp, a ceiling lamp, a harbor lamp, and a park lamp. That is, the LED lighting devices according to the embodiments of the present invention may be installed on a pillar of a street lamp, a wall or a ceiling, for example. The LED lighting device according to one embodiment of the present invention may be freely adjusted vertically so as to achieve a proper light distribution. For example, the LED lighting device may be adjusted from 70 degrees to 110 degrees.

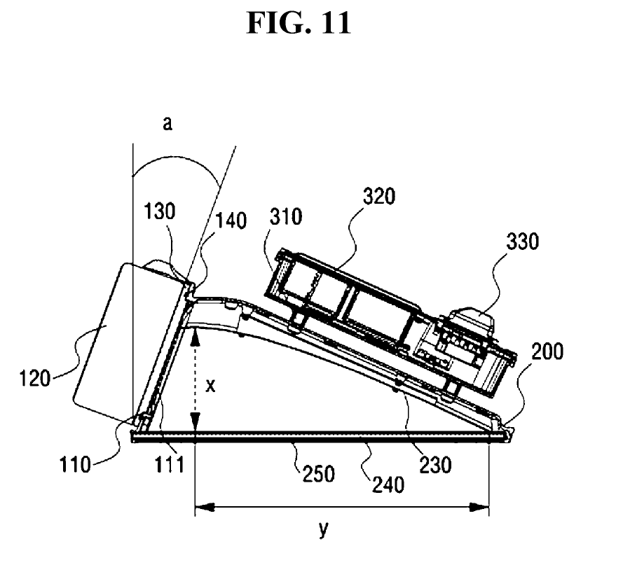

FIG. 11 is a cross-sectional view of an LED lighting device according to one embodiment of the present invention.

Referring to FIG. 11, according to one embodiment of the present invention, in an LED lighting device, the metal plate 130 is inclined with respect to the ground as described above, and inclined by an angle “a” with respect to a direction perpendicular to the light emitting part 210. As described above, the inclined angle “a” is determined by taking the illuminance in the directly downward direction of the light emitting part 210 and the range of the inclined angle “a” may be properly adjusted with reference to design specifications such as a predetermined light distribution.

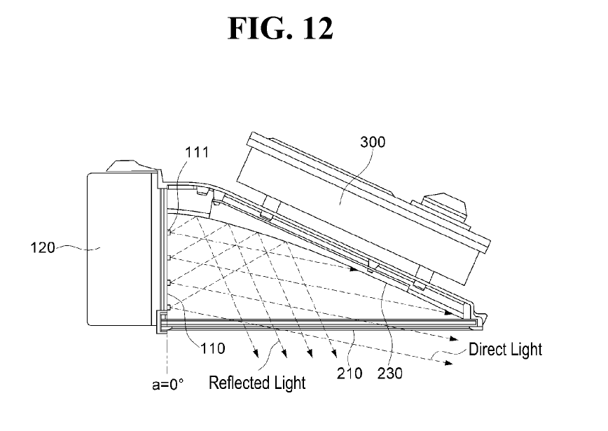

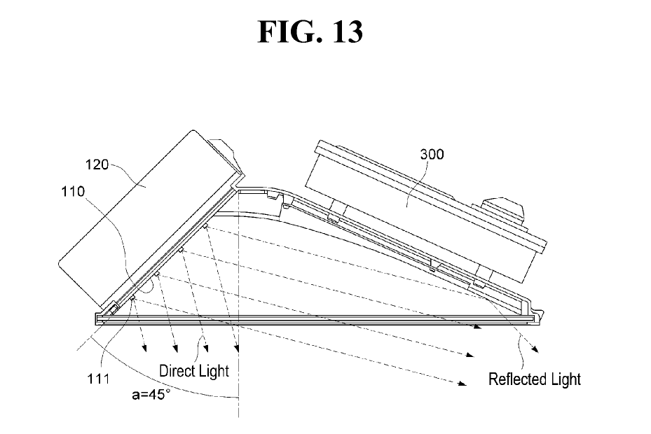

When the inclined angle “a” is too small, the amount of light directly emitted from the LED chips 111 to the light emitting part 210 is too little to obtain a desired light distribution. For example, when the inclined angle “a” is zero (0) degrees as illustrated in FIG. 12, most of the emitted light will be the light reflected through the reflecting part 230 and merely a part of the emitted light will be directly emitted from the lighting unit. Thus, it will be difficult to obtain a suitable light distribution. Whereas, when the inclined angle “a” is too large, the amount of light directly emitted from the light emitting part 210 will be too large to obtain the desired light distribution. For example, when the inclined angle “a” is 45 degrees as illustrated in FIG. 13, most of the emitted will be direct light directly emitted to the light emitting part 210 and the light reflected through the reflecting part 230 will be merely a part of the emitted light, so that it is difficult to obtain the desired light distribution. According to one embodiment of the present invention, the inclined angle “a” may be but not exclusively larger than zero (0) degrees and smaller than 45 degrees. This limit for the inclined angle “a” is determined in consideration of the fact that due to the use of low power LEDs, the present invention uses more LEDs than the prior art, and thus, the necessity to control the light distribution is high.

According to one embodiment of the present invention, when a straight line is indicated vertically from the peak of the reflecting part 230 from the light emitting part 210, the ratio between the height “x” of the peak of the reflecting part 230 from the light emitting part 210 and the length “y” from the intersection point between the reflecting part 230 and the light emitting part 210 to the intersection point of the light emitting part 210 and the straight line also has an influence on the light distribution characteristic of the present invention (FIG. 11). For example, it can be seen that the ratio of y/x in the lighting device of FIG. 13 is relatively large compared to that in the lighting device of FIG. 12 and thus, the lighting devices become different from each other in terms of the light distribution characteristic. The length “y” and the height “x” may be preferably set to implement the pre-set light distribution characteristic when the light emitted through the light emitting part 210. In particular, it is preferable that the reflecting part 230 is designed such that the length “y” exceeds two times the height “x” and smaller than seven times the height “x”. A more excellent light distribution characteristic can be obtained in this aspect ratio.

According to one embodiment of the present invention, the ratio in luminous flux between the light directly distributed from the light sources (direct light) and the light distributed by being reflected through the reflecting part (reflected light) may be adjusted in a range of 4:6 to 6:4.

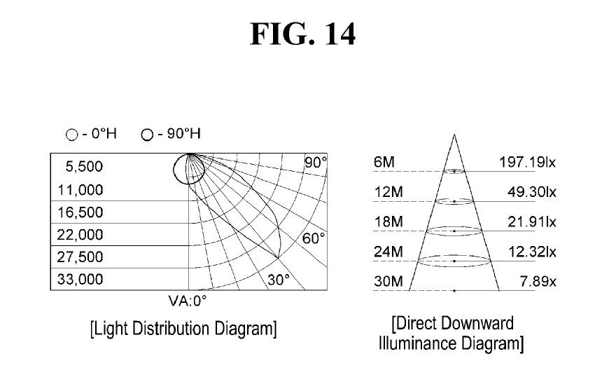

FIG. 14 illustrates a light distribution diagram and a direct downward illuminance diagram of a lighting device according to one embodiment of the present invention. The lighting device used 0.2 watt low-power LED chips, the power consumption of the lighting device was 300 watt, and the ratio in luminous flux between direct light and reflected light was 51.4:48.6. The light distribution diagram and the directly downward illuminance diagram illustrated in FIG. 14 and the ratio in luminous flux between the direct light and the reflected light can be obtained by properly adjusting, for example, the inclined angle “a” and the ratio of y/x as described above.

Still another embodiment of the present invention provides an LED lighting device including: a lighting unit including a substrate, on which a plurality of low-power LED chips are mounted; a housing including a bottom face, a first inclined face formed an acute angle with the bottom face, and a second inclined face connected with the first inclined face, opposite ends of the bottom face, the first inclined face, and the second inclined face are connected with each other to form an inner space defined by the bottom face, the first inclined face, and the second face as boundaries; and a reflecting part on an inner face of the housing to reflect light generated from the lighting unit. At least a part of the lighting unit is inserted through a part of the first inclined face such that the low-power LED chips are directed to the inner space of the housing.

The LED lighting devices according to the above-described embodiments of the present invention have various advantages. For example, each of the lighting unit and the power supply is capable of being thermally isolated from the other structural elements and individually releasing (radiating) heat so that thermal conduction between the lighting unit and the power supply and hence reduction of the lifespan can be suppressed. In addition, since the housing may be made of a material having a relatively low thermal conductivity through injection molding, the thermal conduction between the lighting unit and the power supply can be suppressed. Furthermore, since the heat insulation sealing unit configured to block thermal conduction is disposed between the lighting unit and the housing, the thermal conduction between the lighting unit and the housing (and the power supply) can be suppressed. Moreover, since the housing includes a modified type of a frame that fixes the cover that covers the light emitting face, the deformation and damage of the frame can be prevented, thereby improving the productivity.

In addition, since the lighting unit and the power supply can be manufactured in the form of separated pieces, an optimized weight and structure can be implemented. In particular, since the housing, the lighting unit, and the power supply can be manufactured in the form of separated pieces, the productivity can be enhanced at the time of mass production and hence the manufacturing costs can be reduced.

In addition, the LED lighting devices of some embodiments may further include the angle adjusting unit pivotally coupled with the lighting unit, in which since the structure or shape of the arm socket assembled with the pivot bracket of the angle adjusting unit is variable, the illumination direction may be maintained regardless of the installation position of the lighting device, such as a ground, a ceiling, or a wall. Accordingly, the LED lighting devices can be applicable to various illumination fields and can be used for various purposes. In addition, even if low-power LED chips are used, the LED lighting devices may obtain a desired light distribution, heat generation caused by the use of the high-power LED chips can be reduced, and the weight and volume of the LED lighting devices can be reduced. In addition, since the LED lighting devices can be wirelessly controlled in terms of illumination, it is very convenient to operate the LED lighting devices.

The lighting device according to one embodiment of the present invention may be used for a floodlighting device with high-output illumination of 100 watts or more.

The floodlighting device refers to a lighting device that collects light emitted from a light source so as to illuminate a distant place and is mainly used as a lamp for a vehicle or a ship which illuminates a distant location or lamps for external walls of building, an outdoor work area or a sport facility, for example. In particular, an outdoor floodlighting device has a large scale and consumes a very large amount of resource and power. Thus, it is necessary to reduce the consumption of resource and power as much as possible. The lighting devices according to the embodiments of the present invention can achieve desired heat radiation and light distribution characteristics with a relatively size, and thus, can be used more efficiently in floodlighting.

LED lighting devices according to the present invention are applicable to various since they are excellent in heat radiation characteristic and production efficiency, they may be manufactured with high productivity, they may allow an entire weight and volume of a final product to be reduced, and they enable a smooth light distribution control.

Although the present invention has been described with reference embodiments, a person ordinarily skilled in the art to which the present invention belongs will understand that the present invention is not limited to the embodiments and can be variously changed or modified without departing from the scope of the present invention.

What is claimed is:

1. An LED lighting device comprising:
a lighting unit provided with a plurality of LEDs as a light source to generate;
a housing including an opening provided on a first face, a light emitting part provided on a second face, which is opposite to the first face, to emit light outwardly, and an inner space;
a reflecting part provided on an inner face of the housing to reflect light generated from the lighting unit to the light emitting part; and
a heat radiation unit provided on a rear face of the lighting unit to be exposed outwardly so as to radiate heat outwardly,
wherein the lighting unit is installed to cover the opening such that its front face is directed toward the inner space of the housing, and the light emitting part is installed to emit the light generated from the lighting unit or to emit light reflected through the reflecting part from the lighting unit.

2. The LED lighting device of claim 1, wherein the lighting unit includes a substrate, a plurality of LEDs disposed on the substrate, and a metal plate that supports the substrate.

3. The LED lighting device of claim 1, wherein the plurality of LEDs provided as the light source are 0.2 to 0.5 watt low-power LEDs.

4. The LED lighting device of claim 3, wherein the low-power LEDs are disposed to be distributed at an interval narrower than that of high-power LEDs that provide an output equal to that of the low-power LEDs for an equal area with a power higher than the power of the low-power LEDs.

5. The LED lighting device of claim 1, wherein the plurality of LEDs of the light source are of a COB (Chip On Board) type.

6. The LED lighting device of claim 2, wherein the metal plate is installed at an angle that exceeds zero (0) degrees and is smaller than 45 degrees with respect to a direction perpendicular to the light emitting part.

7. The LED lighting device of claim 1, wherein the lighting unit is detachable from/attachable to the housing.

8. The LED lighting device of claim 1, wherein the reflecting part includes a plurality of reflecting faces, and
the reflecting faces have different inclined angles, different areas, different curvatures, or at least two thereof, respectively, to implement a pre-set light distribution characteristic when the light is emitted through the light emitting part and formed on an inner ceiling of the housing.

9. The LED lighting device of claim 1, wherein the reflecting part is installed on each of opposite side faces of the housing.

10. The LED lighting device of claim 1, wherein the reflecting part is detachable from/attachable to the housing.

11. The LED lighting device of claim 1, wherein a ratio in luminous flux between light directly distributed from the light source and light distributed by being reflected through the reflecting part is 4:6 to 6:4.

12. The LED lighting device of claim 1, wherein a straight line is indicated vertically from a peak of the reflecting part from the light emitting part, a height “x” to the peak of the reflecting part from the light emitting part and a length “y” from an intersection point of the light emitting part and the straight line to a point where the reflecting part and the light emitting part are in contact with each other are set to implement a pre-set light distribution characteristic when the light is emitted through the light emitting part.

13. The LED lighting device of claim 12, wherein a ratio of the length “y”/the height “x” exceeds two times and is smaller than seven times.

14. The LED lighting device of claim 1, wherein the lighting unit is inserted into and coupled to the opening.

15. The LED lighting device of claim 1, further comprising:
a cover that covers the light emitting part; and
a fixing frame that fixes the cover to the housing.

16. The LED lighting device of claim 15, wherein the fixing frame is divided into a plurality of frames and each of the divided frames have stepped portions at opposite ends thereof such that one stepped portion of one divided frame is engaged with another divided frame to be assembled with the one divided frame.

17. The LED lighting device of claim 1, wherein the housing is an injection-molded product.

18. The LED lighting device of claim 1, further comprising:
a heat insulation sealing unit between the housing and the lighting unit.

19. The LED lighting device of claim 1, wherein the heat radiation unit includes a plurality of heat radiation fins.

20. The LED lighting device of 19, wherein the plurality of heat radiation fins are formed to form an inclination with respect to a ground.

21. The LED lighting device of claim 2, wherein the metal plate and the heat radiation unit have a thermal conductivity higher than that of the housing.

22. The LED lighting device of claim 2, wherein the metal plate and the heat radiation unit are extrusion-molded products.

23. The LED lighting device of claim 1, further comprising:
a power supply which is mounted on an outer face of the housing to be detachable/attachable and supplies power to the lighting unit.

24. The LED lighting device of claim 23, wherein the power supply includes a fastening lug which is mounted on the outer face of the housing to be in contact with an outer top surface of the housing with a gap being interposed between the power supply and the outer top surface of the housing.

25. The LED lighting device of claim 23, further comprising:
a heat radiation unit outside the power supply.

26. The LED lighting device of claim 23, wherein the heat radiation unit is formed to be inclined with respect to the ground.

27. The LED lighting device of claim 1, further comprising:
an angle adjusting unit that allows tilting and pivoting of the LED lighting device.

28. The LED lighting device of claim 27, wherein the angle adjusting unit includes:
a first pivot bracket fixed to one side end of a rear face of the lighting unit;
a second pivot bracket fixed to the other side end of the rear face of the lighting unit ;
a pivot fame pivotally connected with the first pivot bracket at one end and pivotally connected with the second pivot bracket at the other end; and
an arm socket coupled to a part of the pivot frame to be attachable/detachable.

29. The LED lighting device of claim 1, further comprising:
an antenna mounted outside the power supply to receive a wireless signal for adjusting power supplied to the lighting unit; and
a controller that controls supply of the power according to the wireless signal received through the antenna.

30. An LED lighting device comprising:
a lighting unit including a substrate, on which a plurality of low-power LED chips are mounted
a housing including a bottom face, a first inclined face formed an acute angle with the bottom face, and a second inclined face connected with the first inclined face, opposite ends of the bottom face, the first inclined face, and the second inclined face being connected with each other to form an inner space defined by the bottom face, the first inclined face, and the second face as boundaries; and
a reflecting part on an inner face of the housing to reflect light generated from the lighting unit,
wherein at least a part of the lighting unit is inserted through a part of the first inclined face such that the low-power LED chips are directed to the inner space of the housing.
